(19) United States
(12) Patent Application Publication
(10) Pub. No.: US 2010/0020045 A1
(43) Pub. Date: Jan. 28, 2010

(54) Optically enhanced flat panel display system having integral touch screen

(76) Inventors: Kevin Walsh, Dawsonville, GA (US); Mark Fletcher, Cumming, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 11/206,450

(22) Filed: Aug. 18, 2005

(51) Int. Cl. G09G 3/36; G06F 3/042

(52) U.S. Cl. 345/176; 345/102

(57) ABSTRACT

An optically enhanced flat panel display system, including apparatuses and methods for assembling same, for displaying images generated by a computer or electronic device with increased luminance and reduced reflectance, and for receiving user input for a computer or electronic device via a touch screen portion thereof. The flat panel display system comprises a touch screen portion integrally incorporated with and forward of a display portion. The display system has only one front polarizer such that the touch screen and display portions are generally positioned rearward thereof. In exemplary embodiments, the touch screen portion employs resistive touch screen technology and the display portion employs liquid crystal display technology. By including only one front polarizer, attenuation of display image light is minimized and an increase in net luminance is achieved over other flat panel display systems.

### FIELD OF THE INVENTION

The present invention relates generally to the field of flat panel display systems and more specifically to liquid crystal displays employed in connection with touch screens.

### BACKGROUND OF THE INVENTION

Since their initial development, flat panel display systems with active matrix liquid crystal displays (“AMLCDs”) have become increasingly popular for the display of computer-generated data in residential, commercial, and military environments. To enable user interaction with the computers that generate such data, manufacturers have coupled AMLCDs with touch screens that allow users to select a displayed item or otherwise provide an input to the computers by merely touching a user-accessible front cover panel of the touch screens.

For example, some flat panel display systems that are employed in the cockpits of certain military aircraft have AMLCDs equipped with touch screens based on infrared touch technology. Using such a flat panel display system, a pilot may select a displayed item or provide an input to an aircraft computer by simply touching a front cover panel of the infrared touch screen. Unfortunately, such flat panel display systems do not always perform well when direct sunlight impinges upon them as may happen during an aircraft's flight. Such flat panel display systems also tend to require complex hardware and/or software, making them more expensive to manufacture. Further, the infrared circuitry of such flat panel display systems must be packaged within the display's bezel, thereby preventing the display's active area from extending close to the outside edges of the display bezel.

In an attempt to overcome some of these difficulties of flat panel display systems equipped with infrared touch screens, manufacturers have integrated AMLCDs in flat panel display systems with touch screens that utilize resistive technology to detect the existence and x-y locations of user inputs relative to the boundaries of the screens. In such flat panel display systems, a resistive touch screen is placed in front of the display system's AMLCD. Unfortunately, such flat panel display systems suffer from a loss of luminance due to excess light filtering caused by the presence of redundant polarizers in the AMLCDs and resistive touch screens.

Therefore, there exists in the industry a need for a flat panel display system having a touch screen input device that addresses these and other problems or difficulties that exist now or in the future.

### SUMMARY OF THE INVENTION

Broadly described, the present invention comprises an optically enhanced flat panel display system, including apparatuses and methods, for displaying images generated by a computer or electronic device with increased luminance and reduced reflectance, and for receiving user input for a computer or electronic device via a touch screen portion thereof. More particularly, the present invention comprises a flat panel display system having a touch screen portion integrally incorporated with and forward of a display portion. The flat panel display system has only one front polarizer such that the touch screen and display portions are positioned rearward thereof. Because the flat panel display system of the present invention has only a single front polarizer, the display system's net luminance is improved over prior art devices having multiple front polarizers that tend to attenuate light passing therethrough. Also, such improvement in net luminance is achieved without reducing the display system's contrast or color performance.

In the exemplary embodiments described herein, the touch screen and display portions are arranged in configurations in which they are either separated by an air gap or are secured in contact with one another. Advantageously, in those configurations where the touch screen and display portions are separated by an air gap, the replacement of a faulty touch screen portion or display portion may be performed with relative ease as the flat panel display systems may be readily disassembled and reassembled with a working touch screen or display portion. In the configuration in which the touch screen and display portions are secured in contact with no air gap therebetween, reflections are beneficially reduced as compared to the other configurations (or compared to prior art devices) and, hence, the visibility and clarity of the images displayed by the flat panel display system is less effected and reduced by sunlight impinging thereon. Additionally, due at least in part to the touch screen and display portions being secured in contact, the flat panel display system's resistance to image white out and to display damage from high z-axis vibration is improved.

Generally, in the exemplary embodiments, the touch screen portion comprises a resistive touch screen subassembly and the display portion comprises an active matrix liquid crystal display subassembly. Because the touch screen portion utilizes resistive touch screen technology, there is no need to package touch screen circuitry in the display's bezel as with other technologies and, therefore, the display's active area may be extended nearer the outside edges of the display bezel. It should be noted that while the touch screen portion comprises a resistive touch screen subassembly and the display portion comprises an active matrix liquid crystal display subassembly in the exemplary embodiments described herein, the scope of the present invention is not limited to the use of touch screens employing resistive technology or to displays employing liquid crystal technology.

Other advantages and benefits of the present invention will become apparent upon reading and understanding the present specification when taken in conjunction with the appended drawings.

### BRIEF DESCRIPTION OF THE DRAWINGS

FIG. 1 is a side view of a flat panel display system in accordance with a first exemplary embodiment of the present invention.

FIG. 2 is a side view of a flat panel display system in accordance with a second exemplary embodiment of the present invention.

FIG. 3 is a side view of a flat panel display system in accordance with a third exemplary embodiment of the present invention.

FIG. 4 is a side view of a flat panel display system in accordance with a fourth exemplary embodiment of the present invention.

FIG. 5 is a side view of a flat panel display system in accordance with a fifth exemplary embodiment of the present invention.

FIG. 6 is a pictorial representation of a method of light propagation through the flat panel display systems of the exemplary embodiments of the present invention.

### DETAILED DESCRIPTION OF THE INVENTION

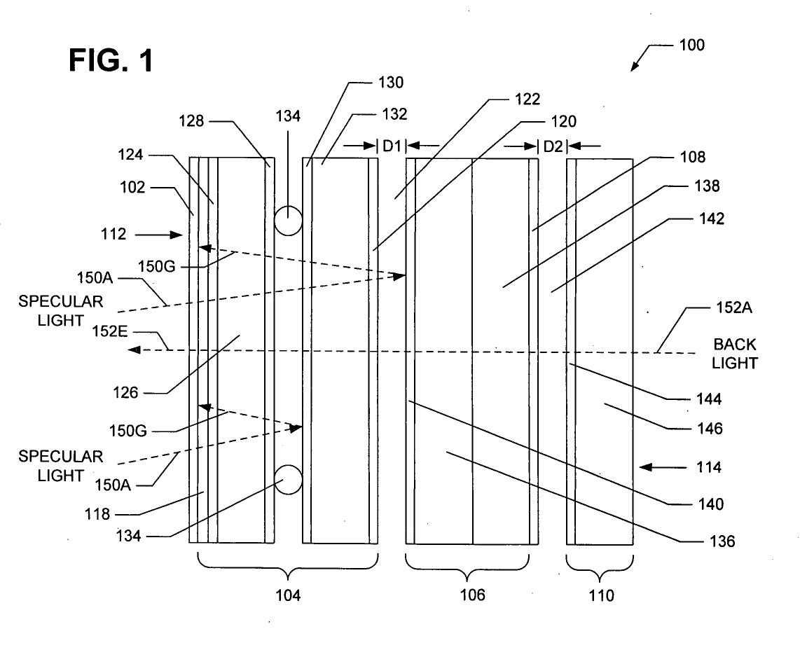

Referring now to the drawings in which like numerals represent like elements or steps throughout the several views, FIG. 1 displays a side view of a flat panel display system 100 in accordance with a first exemplary embodiment of the present invention. The flat panel display system 100 comprises a single front polarizer 102, a resistive touch screen portion 104, an AMLCD portion 106, a single rear polarizer 108, and an AMLCD heater portion 110 that are arranged as layers in a substantially sandwich-like structure. The flat panel display system 100 has a front 112 and back 114 with the front polarizer 102, the resistive touch screen portion 104, the AMLCD portion 106, the rear polarizer 108, and the AMLCD heater portion 110 being sequentially and substantially adjacently arranged between the display system's front 112 and back 114. The flat panel display system 100 is adapted to receive light, during operation, from a light source (not shown) that is located proximate the back 114 thereof. The light, referred to herein as “back light”, is directed at the display system's back 114 and in a direction toward the display system's front 112 so as to provide light that is transmitted, as appropriate, by the AMLCD portion 106 to define the images (also, perhaps, referred to herein as “display image light”) being displayed by the display system 100.

The front polarizer 102, generally, has anti-reflective and hard coatings on its surfaces and comprises the only front polarizer of the flat panel display system 100. The front polarizer 102 is, typically, bonded to the front surface of the resistive touch screen portion's first quarter wave plate 118 (described below). Such bonding (as are other bonding operations identified herein) is performed using conventional techniques that should be known to one of ordinary skill in the art. The front surface of the front polarizer 102 is, in most installations of the flat panel display system 100, accessible to users and is configured to be slightly deflected, or flexed, by such users when they attempt to select displayed items or provide input to a computer communicatively connected to the flat panel display system 100 by applying pressure to the front surface with a finger, stylus, or other selection or pointing device. The front polarizer's hard coating aids in protecting the front polarizer 102 (and, for that matter, the flat panel display system 100) from damage due to outside sources and the anti-reflective coating enables the front polarizer 102 to block reflected light.

The resistive touch screen portion 104 (also, perhaps, referred to herein as the “resistive touch screen subassembly 104”) of the flat panel display system 100 is adapted to receive, during use, a selection of a item displayed by the AMLCD portion 106 or other input provided by a user through the application of pressure to the display system 100 with a finger, stylus, or other selection or pointing device, and to produce a voltage division representative of the x-y location of the applied pressure to connected (via interface wires not shown) electrical circuitry in a manner similar to conventional resistive touch screen devices. The resistive touch screen portion 104 comprises opposed first and second quarter wave plates 118, 120 that are, generally, adapted to cancel glare and allow the passage of light therethrough with very minimal light absorption. The first quarter wave plate 118 is positioned adjacent to the front polarizer 102 and is, typically, bonded thereto. The first quarter wave plate 114 is more particularly adapted to convert linearly-polarized light received from the front polarizer 102 into circularly polarized light, to convert circularly-polarized reflected light into linearly-polarized light for absorption by the front polarizer 102, and to convert circularly-polarized display image light for transmission by the front polarizer 102.

The second quarter wave plate 120 is positioned such that it is substantially opposed and parallel to the display system's AMLCD portion 106, but separated therefrom by a first air gap 122. According to the first exemplary embodiment, the first air gap 122 defines a distance, D1, between the resistive touch screen and AMLCD portions 104, 106 that has a measure of approximately 0.5 to 5.0 millimeters. It should be noted, however, that if vibration may be an issue in a particular implementation of the flat panel display system 100, the first air gap 122 might be eliminated with the second quarter wave plate 120 being bonded directly to the front surface of the display system's AMLCD portion 106. The second quarter wave plate 120 is adapted to convert circularly-polarized light incident thereon into linearly-polarized light, convert linearly-polarized reflected light into circularly-polarized light, and convert linearly-polarized display image light into circularly-polarized light.

The resistive touch screen portion 104 further comprises an electromagnetic interference (EMI) shield 124, a touch front glass 126, a touch front resistance surface 128, a touch rear resistive surface 130, and a touch rear glass 132 positioned between the first and second quarter wave plates 118, 120. The electromagnetic interference shield 124 is positioned adjacent to, and interposed between, the first quarter wave plate 118 and the touch front glass 126. Typically, the electromagnetic interference shield 124 has an indium-tin oxide coating and is bonded to the first quarter wave plate 118 and the front surface of the touch front glass 126. In order to minimize light absorption, the electromagnetic interference shield 124 has a refractive index that is, generally, matched with the first quarter wave plate 118 and the touch front glass 126. When the flat panel display system 100 is in use, the electromagnetic interference shield 124 provides boundary protection against electromagnetic interference radiated emissions or susceptibility.

The touch front glass 126 provides a substrate for the touch front resistive surface 128 (described below) and has, according to the first exemplary embodiment, a thickness in the front-to-back direction measuring approximately 0.2 millimeters. The thickness of the touch front glass 126 is selected so as to enable the touch front glass 126 to deflect or flex, when the flat panel display system 100 is in use and a displayed item is selected by a user, by an amount sufficient to cause the touch front resistive surface 128 and touch rear resistive surface 130 to come into contact. Thus, it should be noted that the touch front glass 126 might have different thicknesses in different implementations of the flat panel display system 100 as is necessary to enable sufficient deflection or flexing thereof.

The touch rear glass 132 is positioned rearward of and substantially parallel to the touch front glass 126 such that the back surface of the touch rear glass 132 is adjacent to and secured to the front surface of the second quarter wave plate 120. Generally, the touch rear glass 132 and second quarter wave plate 120 are bonded together. The touch rear glass 132 provides a substrate for the touch rear resistive surface 128 and has a thickness in the front-to-back direction that is selected so as to resist appreciable deflection, or flexing, during a user's selection of an item displayed by the flat panel display system 100. According to the first exemplary embodiment, the touch rear glass 132 has a thickness of approximately 3 millimeters. It should be noted, however, that the thickness of the touch rear glass 132 might have other measures in other embodiments of the present invention.

The touch front resistive surface 128 is applied and secured to the back surface of the touch front glass 126 such that the touch front resistive surface 128 deflects, or flexes, in substantial unison with the touch front glass 126 during a user's selection of an item displayed by the flat panel display system 100. The touch rear resistive surface 130 is applied and secured to the front surface of the touch rear glass 132, but due at least in part to the rigidity and thickness of the touch rear glass 132, the deflection or flexing of the touch rear resistive surface 130 is limited and minimized during a user's selection of an item displayed by the flat panel display system 100. Respectively, the touch front and rear resistive surfaces 128, 130 comprise front and rear resistive elements of the display system's resistive touch screen portion 104 that function in a manner that is substantially similar to resistive surfaces in common resistive touch screen devices. Typically, the touch front and rear resistive surfaces 128, 130 each have an indium-tin oxide coating.

The resistive touch screen portion 104 further comprises a plurality of touch spacers 134 that are interposed between the touch front and rear resistive surfaces 128, 130. The touch spacers 134 prevent the touch front resistive surface 128 and the touch rear resistive surface 130 from coming into contact absent deflection, or flexing, of the front polarizer 102, first quarter wave plate 118, electromagnetic interference shield 124, and touch front glass 126. Generally, the touch spacers 134 are manufactured from a material that is electrically non-conductive.

The AMLCD portion 106 (also, perhaps, referred to herein as the “AMLCD subassembly 106” or the “display portion 106”) of the flat panel display system 100 is communicatively connectable to a computer system or other similar device through a conventional AMLCD interface (not shown) and is operable to selectively transmit and/or block back light through appropriate electrical energization/de-energization of a liquid crystal material therein in order to produce images (e.g., represented by display image light) visible to a user of the flat panel display system 100. The AMLCD portion 106 of the flat panel display system 100 comprises first and second AMLCD glass panels 136, 138 that define a cell gap therebetween (not shown) in which the liquid crystal material resides. The first AMLCD glass panel 136 is oriented substantially parallel to the second AMLCD glass panel 138, the second quarter wave plate 118, and the rear polarizer 108. Generally, the first and second AMLCD glass panels 136, 138 comprise AMLCD glass panels found in conventional AMLCD displays. The front surface of the first AMLCD glass panel 136 has an anti-reflective coating 140 applied thereto. The anti-reflective coating 140 and the second quarter wave plate 118 define first air gap 122 therebetween. The rear polarizer 108 is oriented adjacent to the second AMLCD glass panel 138 with the rear polarizer's front surface being secured to the back surface of the second AMLCD glass panel 138, generally, by bonding. The rear polarizer 108 has an anti-reflective coating to reduce light reflection.

The AMLCD heater portion 110 (also, perhaps, referred to herein as the “AMLCD heater subassembly 110” or “display heater 110”) is configured to warm the AMLCD portion 106 of the flat panel display system 100. Such warming is necessary to eliminate sluggish response of the liquid crystal material. The AMLCD heater portion 110 is positioned substantially parallel to and rearward of the display system's rear polarizer 108 and defines a second gap 142 with the rear polarizer 108. The second gap 142, in accordance with the first exemplary embodiment, defines a distance, D2, between the AMLCD heater portion 110 and rear polarizer 108 that has a measure of approximately 0.5 to 5.0 millimeters. It should be noted, however, that if vibration may be an issue in a particular implementation of the flat panel display system 100, the second air gap 142 may be eliminated with the AMLCD heater portion 110 being bonded directly to the back surface of the display system's rear polarizer 108.

The AMLCD heater portion 110 comprises a resistive heater element 144 that is configured to supply heat, across second gap 142, to the rear polarizer 108 and, hence, to the second AMLCD glass panel 138. The liquid crystal material is warmed through its contact with the second AMLCD glass panel 138. The resistive heater element 144 has refractive index that is, generally, matched with the heater glass 146 to minimize light absorption. The resistive heater element 144 also, typically, has an indium-tin oxide coating.

The AMLCD heater portion 110 further comprises a heater glass 146 located rearwardly adjacent to and in contact with the resistive heater element 144. The heater glass 146 provides a substrate for the resistive heater element 144 such that the resistive heater element 144 is, generally, bonded to the heater glass 146. The heater glass 146 also serves to add rigidity and stiffening to the flat panel display system 100.

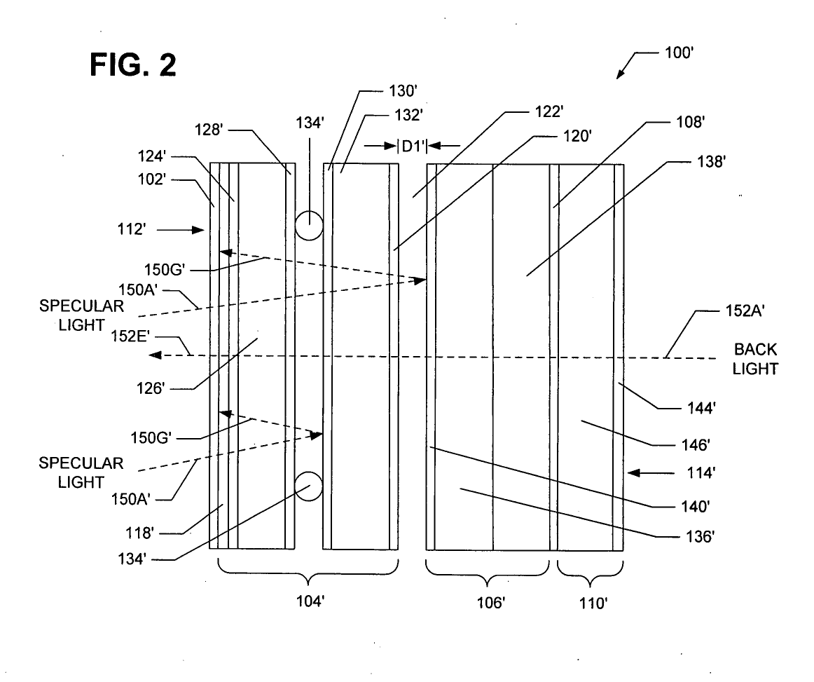

FIG. 2 displays a side view of a flat panel display system 100′ in accordance with a second exemplary embodiment of the present invention. The flat panel display system 100′ is substantially similar in structure and operation to the flat panel display system 100 of the first exemplary embodiment, albeit with a few differences. For example, in the flat panel display system 100′ of the second exemplary embodiment, there is no air gap between the AMLCD and AMLCD heater portions 106′, 110′. The AMLCD heater portion 110′ is secured (generally, by bonding) directly to the AMLCD portion 106′. Also, in the flat panel display system 100′ of the second exemplary embodiment, the resistive heater element 144′ is positioned rearwardly adjacent to and in contact with the rear surface of the heater glass 146′ such that the front surface of the heater glass 146′ is immediately adjacent to and in contact with the back surface of the rear polarizer 108′. Typically, the front surface of the heater glass 146′ is bonded to the back surface of the rear polarizer 108′. In such an arrangement, the heater glass 146′ acts as a stiffener to improve the rigidity of the AMLCD portion 106′.

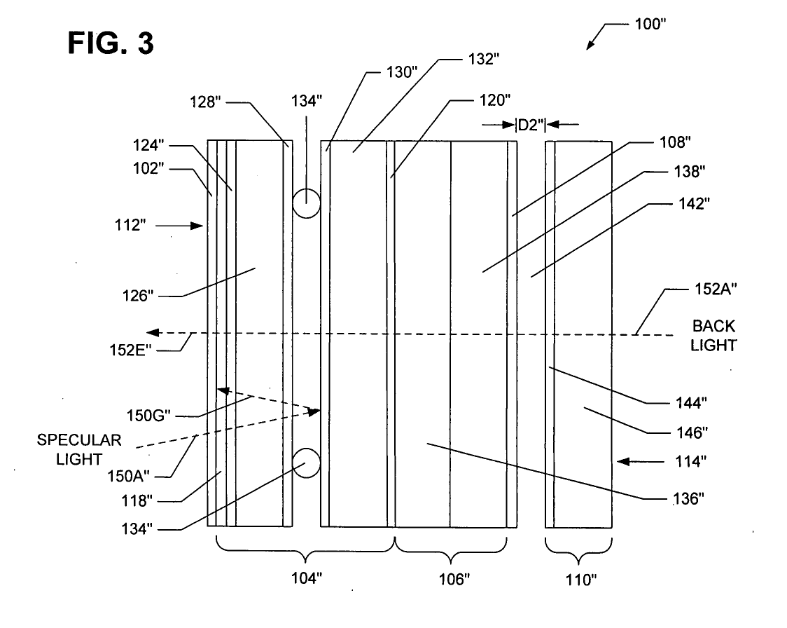

FIG. 3 displays a side view of a flat panel display system 100″, according to a third exemplary embodiment of the present invention, which may be employed when a particular application requires a relatively large flat panel display. The flat panel display system 100″ is substantially similar in structure and operation to the flat panel display system 100 of the first exemplary embodiment with some differences. For example, in the flat panel display system 100″ of the third exemplary embodiment, there is no air gap between the resistive touch screen portion 104′ and the AMLCD portion 106′. The resistive touch screen portion 104′ is secured (generally, by bonding) directly to the AMLCD portion 106′. Also, in the flat panel display system 100″ of the third exemplary embodiment, the front surface of the first AMLCD glass panel 136′ has no anti-reflective coating. As a consequence, the front surface of the first AMLCD glass panel 136′ is immediately adjacent to and in contact with the back surface of the second quarter wave plate 120′. Typically, the front surface of the first AMLCD glass panel 136′ is bonded to the back surface of the second quarter wave plate 120′.

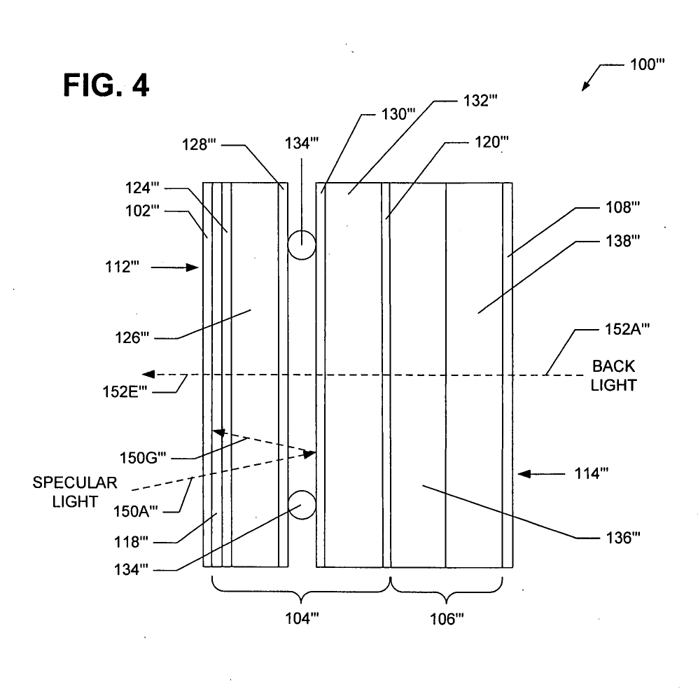

FIG. 4 displays a side view of a flat panel display system 100′″ in accordance with a fourth exemplary embodiment of the present invention. The flat panel display system 100′″ is substantially similar in structure and operation to the flat panel display system 100″ of the third exemplary embodiment. However, the flat panel display system 100′″ of the fourth exemplary embodiment differs from that of the third exemplary embodiment in a few important respects. For example, in the flat panel display system 100′″ of the fourth exemplary embodiment, there is no AMLCD heater portion or heater element and the rear polarizer 108′″ has an anti-reflective coating. As a consequence, the flat panel display system 100′″ of the fourth exemplary embodiment is generally employed in those applications in which it is not necessary to heat the liquid crystal of the AMLCD portion 106′″ thereof.

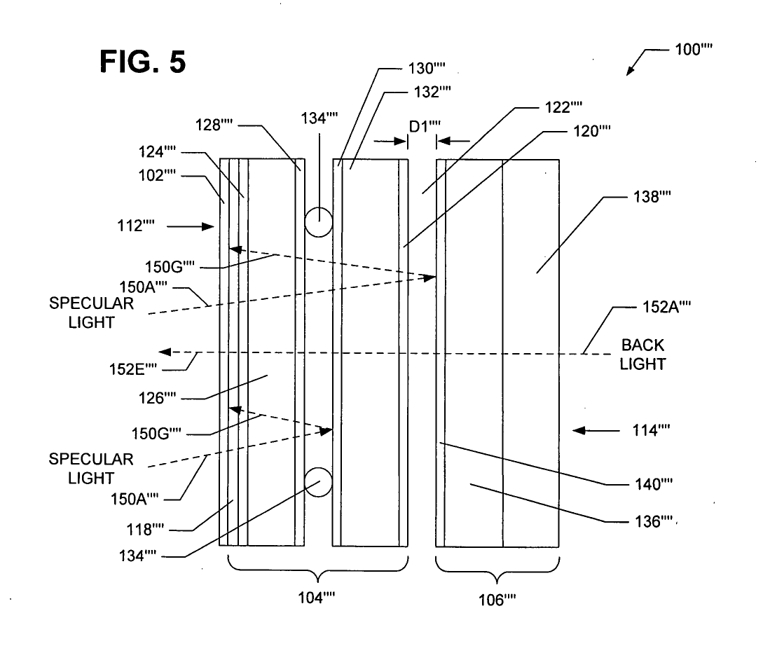

FIG. 5 displays a side view of a flat panel display system 100″″, in accordance with a fifth exemplary embodiment of the present invention, that may also be employed in applications in which it is not necessary to heat the liquid crystal of the AMLCD portion 106′″ thereof. The flat panel display system 100″″ is substantially similar in structure and operation to the flat panel display system 100′ of the second exemplary embodiment except that, in the flat panel display system 100″″ of the fifth exemplary embodiment, there is no AMLCD heater portion or heater element and there is no rear polarizer.

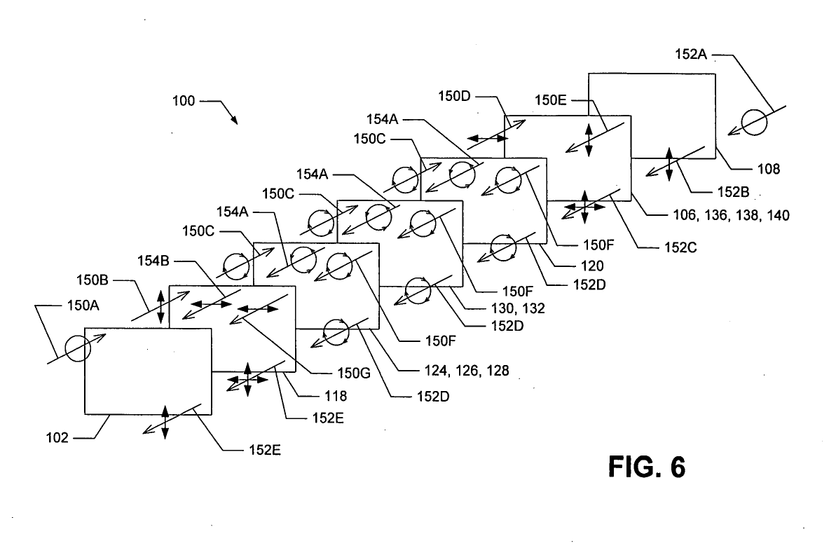

FIG. 6 displays a pictorial representation of a method of light propagation through the flat panel display systems 100 of the exemplary embodiments of the present invention in which common light streams are commonly numbered and changes in associated alpha letters are used to designate changes in the polarization states of the light streams. As illustrated in FIG. 6, light 150A from a non-polarized source (not shown) impinges upon the front surface of the front polarizer 102 of a flat panel display system 100. The polarization of the light 150A is modified as it travels through the front polarizer 102 such that it exits the front polarizer 102 as light 150B linearly polarized in a vertical direction.

The exiting light 150B then impinges upon the front surface of the first quarter wave plate 118. The impinging light 150B passes through and exits the first quarter wave plate 118 as circularly polarized light 150C. After exiting the first quarter wave plate 118, the circularly polarized light 150C then passes through the electromagnetic interference shield 124, touch front glass 126, and touch rear glass 132 with its polarization substantially unchanged. The circularly polarized light 150C subsequently impinges on the front surface of the second quarter wave plate 120 with a first portion of it passing therethrough and a second portion being reflected. During passage of the first portion through the second quarter wave plate 120, the polarization of such impinging light 150C is altered so that it exits the second quarter wave plate 120 as impinging light 150D linearly polarized in a horizontal direction. The exiting light 150D next impinges on the front surface of the first AMLCD glass panel 136 of the display system's AMLCD portion 106 as described below.

The second, or reflected, portion of impinging light 150C is, as noted above, reflected by the front surface of the second quarter wave plate 120 as reflected light 154A and is circularly polarized in the angular direction opposite that of impinging light 150C. The reflected light 154A travels in a substantially opposite direction to impinging light 150C and impinges on and passes through touch rear resistive surface 130 and touch rear glass 132. Upon exiting, reflected light 154A propagates toward electromagnetic interference shield 124 and touch front glass 126. Reflected light 154A passes therethrough substantially unchanged and then impinges on the rear surface of first quarter wave plate 118. While passing through first quarter wave plate 118, the polarization of reflected light 154A is changed such that it exits the first quarter wave plate 118 and impinges on the rear surface of front polarizer 102 as reflected light 154B linearly polarized in the horizontal direction. Then, due at least in part to the horizontal polarization of reflected light 154B, front polarizer 102 absorbs most of reflected light 154B, thereby substantially blocking its further transmission to the environment around the flat panel display system 100.

As described above, impinging light 150D strikes the front surface of the first AMLCD glass panel 136 of the display system's AMLCD portion 106. Upon striking the first AMLCD glass panel 136, the impinging light 150D is reflected as reflected light 150E polarized with at least some change in the polarization state or axis (shown here as the extreme case of ninety degree (90°) rotation of the polarization state or axis). The reflected light 150E then impinges on the back surface of the second quarter wave plate 120, passes therethrough, and exits the second quarter wave plate 120 as reflected light 150F with its polarization changed to circular polarization. Next, the reflected light 150F travels through the touch rear glass 132, touch front glass 126, and electromagnetic interference shield 124 with its polarization substantially unchanged before impinging on the back surface of first quarter wave plate 118. The reflected light 150F passes through the first quarter wave plate 118 where its polarization is modified so that it exits the first quarter wave plate 118 as reflected light 150G that is linearly polarized in a horizontal direction. After exiting the first quarter wave plate 118, the reflected light 150G impinges on the front polarizer 102 where at least some of it is absorbed and not transmitted further.

As also illustrated in FIG. 6, non-polarized back light 152A is directed at the back surface of the rear polarizer 108 from a back light source (not shown) to provide light that is ultimately selectively transmitted and/or blocked by the AMLCD portion 106. The non-polarized back light 152A passes through the rear polarizer 108 and exits as back light 152B polarized in a vertical direction. The back light 152B then impinges on the back surface of the second AMLCD glass panel 138 of the display system's AMLCD portion 106. While passing through the AMLCD portion 106, the polarization of the transmitted portion of the back light 152B is changed such that the back light 152C exiting the display system's AMLCD portion 106 is either vertically or horizontally polarized, depending on the “on” or “off” (e.g., “white” or “black”) state of the pixel intercepted by the back light 152B. The exiting back light 152C then travels through the second quarter wave plate 120 where it is converted to circularly polarized back light 152D. It then passes through the touch rear glass 132, touch front glass 126, and electromagnetic interference shield 124 with its polarization substantially unchanged.

After exiting the electromagnetic interference shield 124, the back light 152D impinges upon the back surface of the first quarter wave plate 118 and passes therethrough. The polarization of the back light 152D is altered by the first quarter wave plate 118 so that the back light 152E exiting the first quarter wave plate 118 is linearly polarized in a horizontal or vertical direction, depending on whether the intercepted pixel was “off” or “on” (e.g., “black” or “white”). The back light 152E subsequently impinges on the front polarizer 102 and is either absorbed (e.g., “off” or “black” state) by the front polarizer 102 or transmitted (e.g., “on” or “white” state) by the front polarizer 102 to the environment around the flat panel display system 100 absent further substantial change to its polarization.

It should be understood that although the flat panel display system 100 of the present invention has been described via the above exemplary embodiments using particular types of polarizers and quarter wave plates and particular orientations and phase angles of the polarization axes (e.g., vertical and horizontal), the scope of the present invention is not limited to such polarizers, quarter wave plates, orientations, and phase angles. Therefore, the scope of the present invention includes other embodiments that may utilize the same or different types of polarizers, quarter wave plates, orientations, and/or phase angles in the same or different combinations and/or relative positions. Further, it should be understood that the scope of the present invention includes other embodiments of the flat panel display system 100 that have or do not have an AMLCD heater portion or heater element.

Whereas this invention has been described in detail with particular reference to exemplary embodiments and variations thereof, it is understood that other variations and modifications can be effected within the scope and spirit of the invention, as described herein before and as defined in the appended claims.

1. (canceled)

2. The flat panel display system of claim 23, wherein a rear polarizer, said touch screen portion, and said display portion are arranged in a configuration in which said touch screen portion is immediately adjacent to said display portion absent contact therewith and in which said touch screen portion and said display portion have a gap therebetween.

3. The flat panel display system of claim 2, wherein said rear polarizer absent contact therewith such that a heater portion and said rear polarizer have a gap therebetween.

4. The flat panel display system of claim 23, wherein a rear polarizer, said touch screen portion, said display portion, and a heater portion are arranged such that said heater portion is immediately adjacent to and in contact with said rear polarizer.

5. The flat panel display system of claim 4, wherein said touch screen portion and said display portion are arranged such that said touch screen portion is immediately adjacent to said display portion absent contact therewith and such that said touch screen portion and said display portion have a gap therebetween.

6. The flat panel display system of claim 23, wherein said touch screen portion and said display portion are arranged such that said touch screen portion is immediately adjacent to and in contact with said display portion.

7. The flat panel display system of claim 6, wherein a heater portion is positioned immediately adjacent to said rear polarizer absent contact therewith such that said heater portion and said rear polarizer have a gap therebetween.

8. The flat panel display system of claim 6, wherein said rear polarizer and said display portion are arranged such that said rear polarizer is immediately adjacent to and in contact with said display portion.

9. The flat panel display system of claim 23, wherein said display portion comprises an active matrix liquid crystal display portion.

10. The flat panel display system of claim 1, wherein said touch screen portion comprises a resistive touch screen portion.

11. (canceled)

12. The flat panel display system of claim 26, wherein said rear polarizer comprises a sole rear polarizer.

13. The flat panel display system of claim 26, wherein said display portion and said touch screen portion define an air gap therebetween.

14. The flat panel display system of claim 26, wherein said display portion is secured to said touch screen portion absent a substantial air gap therebetween.

15. The flat panel display system of claim 26, wherein a heater portion and said display portion define an air gap therebetween.

16. (canceled)

17. (canceled)

18. (canceled)

19. (canceled)

20. (canceled)

21-22. (canceled)

23. A flat panel display system, comprising:
a front polarizer adapted to convert non-polarized external light into linearly polarized light;
a display portion being operable to transmit light defining an image;
a touch screen portion the touch screen portion being adapted to receive user input;
a first quarter wave plate positioned between the front polarizer and the touch screen portion, the first quarter wave plate adapted to convert the linearly-polarized light received from the front polarizer into circularly polarized light;
a second quarter wave plate positioned between the touch screen portion and the display portion, the second quarter wave plate adapted to the convert a first portion of the circularly polarized light into second linearly-polarized light and reflect a second portion of the circularly polarized light in an angular direction opposite that of the circularly polarized light; and
wherein the second portion of the circularly polarized light passes substantially unchanged until passing through the first quarter wave plate, where the polarization of second portion of the circularly polarized light is changed into reflected light linearly polarized that is mostly absorbed by the front polarizer.

24. The flat panel display system of claim 23, wherein the linearly polarized light is in a vertical direction and the reflected light linearly polarized is in a horizontal direction.

25. The flat panel display system of claim 23, wherein a first portion of the second linearly-polarized light is reflected off the display portion as reflected light polarized with some change in the polarization state back through the second quarter wave plate, wherein the second quarter wave plate is further adapted to the convert the reflected light polarized with some change in the polarization state into a third portion of the circularly polarized light, wherein the third portion of the circularly polarized light passes substantially unchanged until passing through the first quarter wave plate, wherein the polarization of third portion of the circularly polarized light is changed into a second reflected light linearly polarized that is mostly absorbed by the front polarizer.

26. A flat panel display system, comprising:
a light source;
a rear polarizer positioned adjacent the front of the light source, the rear polarizer being adapted to convert light from the light source to polarized light;
a display portion having a front and a rear, the display portion being adapted to selectively transmit and/or block the polarized light defining a plurality of displayed items;
a front polarizer positioned for passing on a substantial portion of the polarized light defining the plurality of displayed items and for blocking reflected light;
a touch screen portion located adjacent the front of the display portion, the touch screen portion being adapted to pass on a portion of the polarized light defining the plurality of displayed items and to receive a user selection of a displayed item, the touch screen portion further comprising:
a first quarter wave plate adjacent to the display portion and adapted to convert the polarized light defining the plurality of displayed items into circularly-polarized light;
a touch glass assembly; and
a second quarter wave plate positioned adjacent to the touch glass and adapted to convert circularly-polarized reflected light into linearly-polarized light for absorption by the front polarizer, and to convert circularly-polarized displayed items light for transmission to the front polarizer.

27. The flat panel display system of claim 26, wherein the polarized light defining the plurality of displayed items is either vertically or horizontally polarized, depending on the “on” or “off” state of a pixel intercepted in the polarized light defining a plurality of displayed items

28. A flat panel display system, comprising:
a front polarizer adapted to convert non-polarized external light into linearly polarized light;
a display portion being operable to transmit light defining an image;
a touch screen portion the touch screen portion being adapted to receive user input;
a first quarter wave plate positioned between the front polarizer and the touch screen portion, the first quarter wave plate adapted to convert the linearly-polarized light received from the front polarizer into circularly polarized light and convert circularly-polarized reflected light into linearly-polarized light for absorption by the front polarizer;
wherein some circularly polarized light is converted into circularly-polarized reflected light when striking a reflective surface within the touch screen portion, and passes substantially unchanged until passing through the first quarter wave plate, wherein the circularly-polarized reflected light is changed into reflected light linearly polarized that is mostly absorbed by the front polarizer.
